(19) United States
(12) Patent Application Publication
(10) Pub. No.: US 2008/0112114 A1
(43) Pub. Date: May 15, 2008

(54) PORTABLE ELECTRONIC DEVICE

(75) Inventors: Chih-Cheng Liao, Taipei (TW); Chen-Ming Sun, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/938,793

(22) Filed: Nov. 13, 2007

(30) Foreign Application Priority Data
Nov. 13, 2006 (TW) 95141893

(51) Int. Cl. G06F 1/16

(52) U.S. Cl. 361/680; 361/681; 361/687

(57) ABSTRACT

A portable electronic device includes a casing, an active function area, a passive function area and at least a heat pipe is provided. The active function area is provided inside the casing. The active function area has at least one processor, at least one input device and at least one output device. The passive function area is independent of the active function area. The processor and the passive function area are connected by the heat pipe, by which the heat generated by the processor is conducted. The heat generated by the active function area is conducted by the heat pipe to the independent passive function area effectively. Therefore, the portable electronic device has a better heat dissipating effect.

### CROSS-REFERENCE TO RELATED APPLICATION

This application claims the priority benefit of Taiwan application serial no. 95141893, filed on Nov. 13, 2006. The entirety of the above-mentioned patent application is hereby incorporated by reference herein and made a part of this specification.

### BACKGROUND OF THE INVENTION

1. Field of the Invention

The invention relates to a portable electronic device and, more particularly, to a portable electronic device with an effective heat dissipation structure.

2. Description of the Related Art

Recently, with the development of the semiconductor since and technology, the portable electronic device is developed to be high-speed, miniature and multi-functional. When the functions and speed of the portable electronic device are increased, and the size of the portable electronic device is decreased, the heat generated by each unit of volume of the portable electronic device is greatly increased. Thus, a heat dissipation element becomes an essential element of an electronic device.

FIG. 1 is an exploded diagram showing a conventional electronic device. Please refer to FIG. 1. The electronic device 100 includes a motherboard 110, a heat pipe 120 and a radiating fin 130. A processor 112 is provided on the motherboard 110.

The heat pipe 120 contacts with the processor 112, and the radiating fin 130 is provided on the heat pipe 120. When the processor 112 operates and generates heat, the heat generated by the processor 112 can be conducted to the radiating fin 130 via the heat pipe 120, and then be conducted to the cooler environment via the radiating fin 130.

Since the portable electronic device is multi-functionalized, needed elements are increased, so that room for placing heat dissipation elements in the device body becomes less and less. Since the room is small, the air cannot take away the heat effectively, so that the efficiency of the heat dissipation element in the device body is decreased. Therefore, how can make the heat of the portable electronic device be dissipated effectively becomes an important subject.

### BRIEF SUMMARY OF THE INVENTION

One objective of the invention is to provide a portable electronic device which can conduct the heat to the outside of the processor to dissipate the heat effectively.

A portable electronic device including a casing, an active function area, a passive function area and at least a heat pipe is disclosed. The active function area is provided in the casing, and the active function area has at least a processor, at least an input device and at least an output device. The passive function area is independent of the active function area, and the passive function area does not overlap with the active function area. The heat pipe is connected to the processor and passive function area, wherein the heat pipe is used to conduct the heat generated by the processor.

In one embodiment of the invention, the casing includes a first part and a second part. The first part covers the active function area, and the second part covers the passive function area.

In one embodiment of the invention, the active function area also includes a heat sink and a retainer. The heat sink is provided on the processor and connected to the heat pipe. The retainer fixes the heat pipe and the heat sink on the processor.

In one embodiment of the invention, the passive function area also includes a fan, a driver and a signal connector. The fan is provided at the casing. The driver is used to drive the fan. The signal connector electrically connects the driver to the processor.

In one embodiment of the invention, the passive function area also includes a plurality of radiating fins which are provided in the casing and contact with the heat pipe.

In one embodiment of the invention, the casing has a plurality of heat dissipation holes corresponding to the radiating fins.

In one embodiment of the invention, the passive function area also includes a speaker unit and a signal connector. The speaker unit is provided in the casing. The signal connector electrically connects the speaker unit to the processor.

In one embodiment of the invention, the passive function area also includes a medium control panel which is provided on the casing and electrically connected to the signal connector.

In one embodiment of the invention, the output device includes a display.

In one embodiment of the invention, the input device includes a keyboard.

In the invention, since the heat pipe is used to conduct the heat generated by the active function area to the independent passive function area, the heat can be dissipated more effectively.

In one embodiment of the invention, the portable electronic device further includes an externally connected casing covering the passive function area, and the casing covers the active function area.

These and other features, aspects, and advantages of the present invention will become better understood with regard to the following description, appended claims, and accompanying drawings.

### BRIEF DESCRIPTION OF THE DRAWINGS

FIG. 1 is an exploded diagram showing a conventional portable electronic device.

FIG. 2 is a three-dimensional schematic diagram showing a portable electronic device of one embodiment of the invention.

FIG. 3 is an exploded diagram showing the portable electronic device shown in FIG. 2.

FIG. 4 is a three-dimensional schematic diagram showing the passive function area and the heat pipe of the portable electronic device shown in FIG. 2.

FIG. 5 is a schematic diagram showing the second part and the heat pipe assembled to the first part shown in FIG. 3.

FIG. 6 is a block diagram showing the active function area and the passive function area shown in FIG. 2.

FIG. 7 is a block diagram showing the active function area and passive function area of another embodiment of the invention.

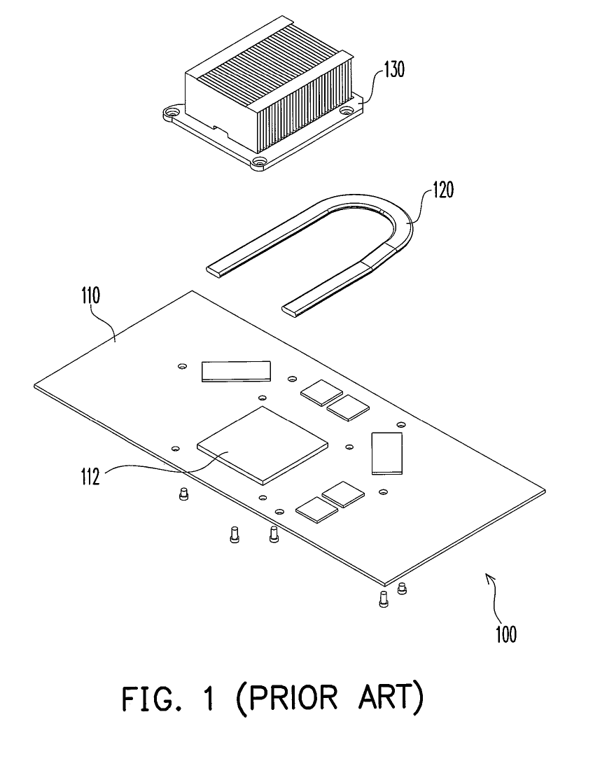

### DETAILED DESCRIPTION OF THE EMBODIMENTS

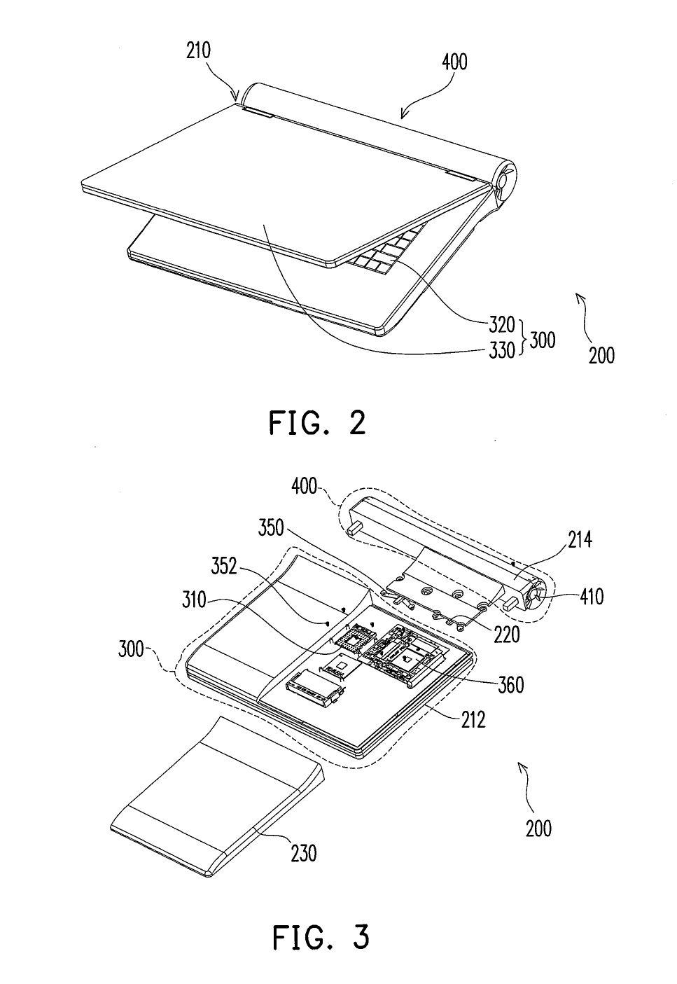

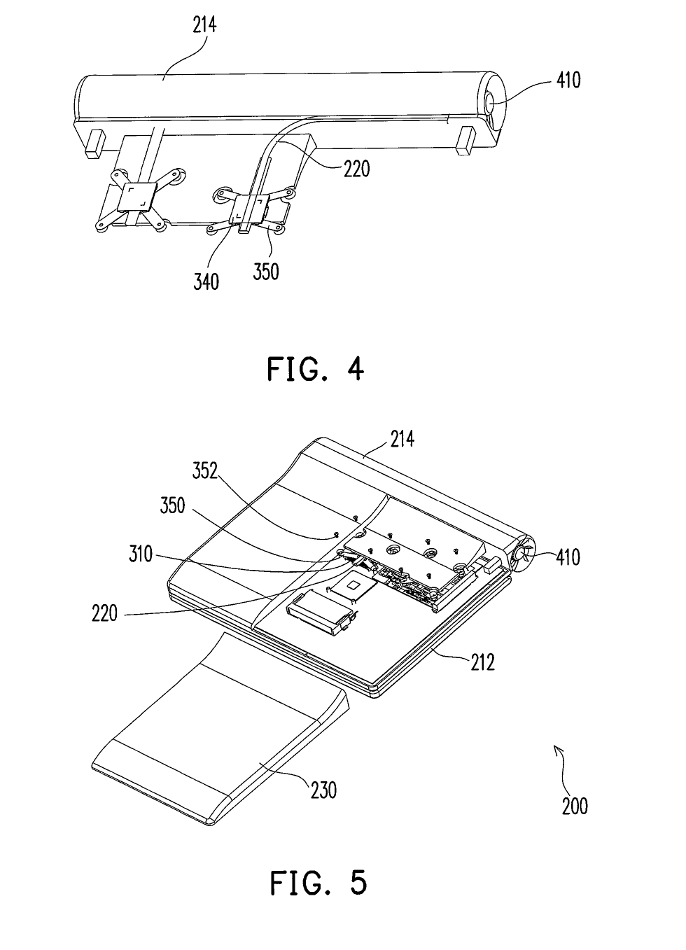

FIG. 2 is a three-dimensional schematic diagram showing a portable electronic device of one embodiment of the invention. FIG. 3 is an exploded diagram showing the portable electronic device shown in FIG. 2. FIG. 4 is a three-dimensional schematic diagram showing the passive function area and heat pipe of the portable electronic device shown in FIG. 2. Although two heat pipes are taken for example in FIGs, a heat pipe also can obtain the effect of the invention.

Please refer to FIG. 2, FIG. 3 and FIG. 4. The portable electronic device 200 includes a casing 210, an active function area 300, a passive function area 400 and a plurality of heat pipes 220. The active function area 300 is provided in the casing 210, wherein the active function area 300 has a processor 310, an input device 320 and an out put device 330.

From the above, the passive function area 400 is independent of the active function area 300, and the passive function area 400 does not overlap with the active function area 300. The active function area 300 is not around the passive function area 400. The heat pipes 220 are connected to the processor 310 and the passive function area 400. The heat pipes 220 are used to conduct the heat generated by the processor 310 when the processor 310 operates to the passive function area 400 to reduce the temperature of the processor 310 and make the portable electronic device 200 keep operating normally.

Since the passive function area 400 is connected to the processor 310 by the heat pipes 220, the heat generated by the processor 310 which operates can be conducted to the passive function area 400 effectively. Since the passive function area 400 is independent of the active function area 300, the passive function area 400 is not affected by the high temperature of the active function area 300. Therefore, a good heat dissipation effect can be obtained.

The heat pipes 220 are not limited to connect the processor 310 and the passive function area 400, and they also can be used to connect other heat generating element in the active function area 300 to the passive function area 400 to further reduce the temperature of the active function area 300. The heat generating element is, for example, graphic processing unit (GPU) 360.

Although one processor 310 is taken for example, persons having ordinary skill in the art also can use a plurality of processors 310 which cooperate with a plurality of corresponding heat pipes 220, which is not limited in the invention.

Although one input device 320 and one output device 330 are taken for example, persons having ordinary skill in the art also can use a plurality of input devices 320 and output devices 330, which is not limited in the invention. The input device 320 can be a keyboard, touch panel or mouse and so on, and the output device 330 can be a display.

Please refer to FIG. 2 and FIG. 3. The casing 210 can be integrally formed, as shown in FIG. 2, and persons having ordinary skill in the art also can use other manners. In the embodiment, the casing 210 can include a first part 212 and a second part 214, and a detachable cover 230 also can be provided at the bottom of the casing 210.

A first part 212 is used to cover the active function area 300, and the second part 214 is used to cover the passive function area 400. The detachable cover 230 covers a first part 212 to protect the elements in the active function area 300. In addition, when assembled, the second part 214 and the heat pipes 220 can be made modules which are independent of the first part 212 to simple the manufacture first. In other embodiment, the casing 210 covers the active function area 300, and an externally connected casing covers the passive function area 400 to make the passive function area 400 be an independent module, which is convenient for users to carry.

FIG. 5 is a schematic diagram showing the second part and heat pipes assembled to the first part show in FIG. 3. Please refer to FIG. 2, FIG. 3 and FIG. 5. When the second part 214 and the heat pipes 220 are assembled to the first part 212, the heat pipes 220 are provided at the active function area 300 and contacts with the processor 310 first, and the second part 214 can be provided at one side of the first part 212. Then, the second part 214 and the heat pipes 220 are fixed on the first part 212, and the heat pipes 220 are connected to the active function area 300 and the passive function area 400. At last, the cover 230 is assembled to the first part 212 to finish assembling.

Since the second part 214 and the heat pipes 220 are modularized, the assembly of the portable electronic device 200 is more flexible, so that the manufacture of the portable electronic device 200 is simplified.

The active function area 300 can include a heat sink 340 and a retainer 350. The heat sink 340 is provided on the processor 310 and connected to the heat pipes 220. The heat sink 340 can make the heat generated by the processor 310 which operates be conducted to the passive function area 400 by the heat pipes 220 more effectively.

From the above, the retainer 350 is used to fix the heat pipes 220 and the heat sink 340 on the processor 310 to make the heat sink 340 contact with the processor 310. The retainer 350 can be fixed on the first part 212 by the fixing elements 352. In the embodiment, the fixing elements 352 are, for example, screws, which is not limited in the invention.

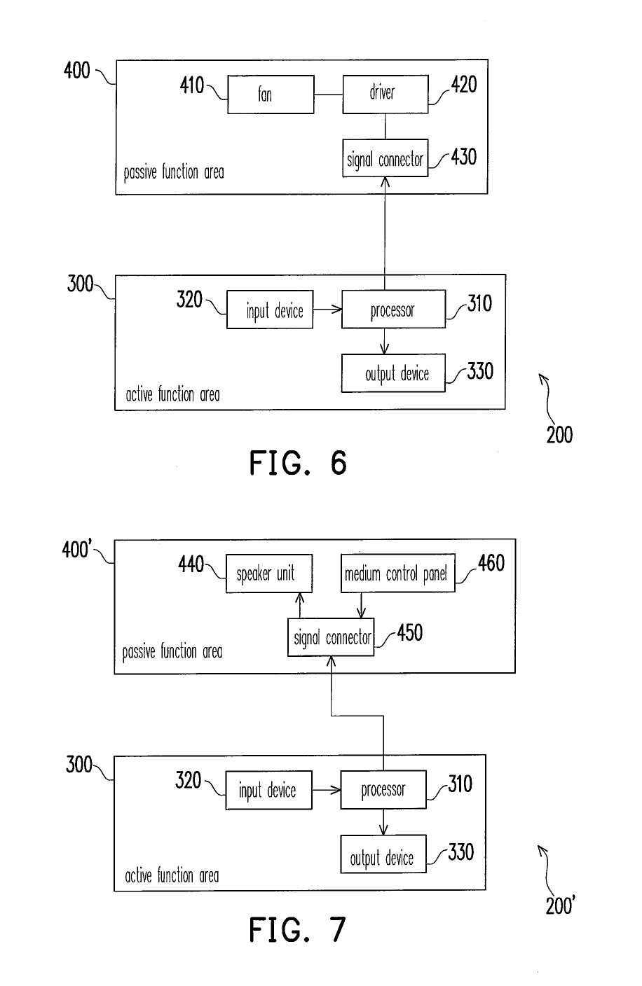

To improve the heat dissipation effect of the passive function area 400, other heat dissipation elements can be added to the passive function area 400. FIG. 6 is a block diagram showing the active function area and passive function area shown in FIG. 2. Please refer to FIG. 5 and FIG. 6. In the embodiment, the passive function area 400 can include a fan 410, a driver 420 and a signal connector 430. The fan 410 is provided in the casing 210, and the signal connector 420 electrically connects the driver 420 to the processor 310 to make the driver 420 drive the fan 410 according to the direction of the processor 310, and then the heat dissipation effect of the passive function area 400 is improved.

In the embodiment, although the fan 410 is, for example, provided at one side of the casing 210, persons having ordinary skill in the art can make it be provided at other position such as the bottom of the casing 210.

To further improve the heat dissipation effect of the passive function area 400, the passive function area 400 can include a plurality of radiating fins (not shown), and the casing 210 can has a plurality of heat dissipation holes (not shown) corresponding to the radiating fins. To obtain a preferred heat dissipation effect, the arrangement of the radiating fins can cooperate with the direction of the air outlet of the fan 410 to increase the contact area of the radiating fins and the air blew by the fan 410. For example, the lengthwise direction of the radiating fins is made parallel to the direction of the air outlet of the fan 410.

Passive function area 400 can be used for the heat dissipation of the portable electronic device 200. Besides, the other functions of the portable electronic device 200 can be modularized if the operation of the active function area 300 is not affected, so that the portable electronic device 200 can be more flexible in assembly.

FIG. 7 is a block diagram showing the active function area and passive function area of another embodiment of the invention. Please refer to FIG. 7. The passive function area 400′ of the portable electronic device 200′ further includes a speaker unit 440 and a signal connector 450. The signal connector 450 electrically connects the speaker unit 440 to the processor 310 to enable the processor 310 to control the speaker unit 440 in the casing 210.

Since the speaker unit 440 is provided in the passive function area 400′, the active function area 300 can have more room, so that the configuration of elements in the active function area 300 is easier, and manufacture of the portable electronic device is simplified. In addition, a medium control panel 460 can also be provided on the casing 210, so that users can use functions such as playing music, play multi-medium audio-visual material and so on.

To sum up, the invention has at least the following advantages:

First, the heat pipe conducts the heat generated by the heat generating element in the active function area to the independent passive function area, so that the portable electronic device has a good heat dissipation effect;

Second, the heat pipe, heat sink and second part are modularized, so that the manufacture of the portable electronic device is simplified;

Third, parts of elements of the portable electronic device are provided in the passive function area, so that the configuration of the elements in the active function area is easier, and the manufacture of the portable electronic device is further simplified.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable electronic device comprising:
a casing;
an active function area provided in the casing, wherein the active function area has at least a processor, at least an input device and at least an output device;
a passive function area which is independent of the active function area, wherein the passive function area does not overlap with the active function area; and
at least a heat pipe which is connected to the processor and the passive function area, wherein the heat pipe is used to conduct the heat generated by the processor.

2. The portable electronic device according to claim 1, wherein the casing comprises a first part covering the active function area and a second part covering the passive function area.

3. The portable electronic device according to claim 1, wherein the active function area also comprises:
a heat sink provided on the processor and connected to the heat pipe; and
a retainer which fixes the heat pipe and the heat sink on the processor.

4. The portable electronic device according to claim 1, wherein the passive function area also comprises:
a fan provided at the casing;
a driver for driving the fan; and
a signal connector electrically connecting the driver to the processor.

5. The portable electronic device according to claim 1, wherein the passive function area also comprises a plurality of radiating fin provided at the casing and connected to the heat pipe.

6. The portable electronic device according to claim 5, wherein the casing has a plurality of heat dissipation holes corresponding to the radiating fins.

7. The portable electronic device according to claim 1, wherein the passive function area also comprises:
a speaker unit provided in the casing; and
a signal connector electrically connecting the speaker unit to the processor.

8. The portable electronic device according to claim 7, wherein the passive function area also comprises:
a medium control panel provided on the casing and electrically connected to the signal connector.

9. The portable electronic device according to claim 1, wherein the output device comprises a display.

10. The portable electronic device according to claim 1, wherein the input device comprises a keyboard.

11. The portable electronic device according to claim 1, further comprising an externally connected casing covering the passive function area, and the casing covering the active function area.
